(19) United States
(12) Patent Application Publication
(10) Pub. No.: US 2024/0395046 A1
(43) Pub. Date: Nov. 28, 2024

(54) MANAGEMENT SYSTEM

(71) Applicant: TOYOTA JIDOSHA KABUSHIKI KAISHA, Aichi-ken (JP)

(72) Inventors: Norimasa KOBORI, Tokyo-to (JP); Yumi SATO, Tokyo-to (JP); Bing XUE, Tokyo-to (JP); Hitoshi KAMADA, Kawasaki-shi (JP); Hsuan-Kung YANG, Tokyo-to (JP); Takashi HOMMA, Tokyo-to (JP); Quan KONG, Tokyo-to (JP)

(21) Appl. No.: 18/639,967

(22) Filed: Apr. 19, 2024

(30) Foreign Application Priority Data
May 24, 2023 (JP) 2023-085221

(51) Int. Cl. G06V 20/52; G06T 7/70

(52) U.S. Cl. CPC G06V 20/52; G06T 7/70; G06T 2207/30232

(57) ABSTRACT

A management system communicates with a moving body having a localization function. The management system acquires an image captured by a moving camera mounted on a moving body and information on a moving camera position which is a position of the moving body when the image is captured. The management system extracts an image of the target area captured by the moving camera as a target area image based on the moving camera position. The management system executes area management process for managing a target area based on the target image.

### CROSS-REFERENCE TO RELATED APPLICATION

This application claims priority to Japanese Patent Application No. 2023-085221 filed on May 24, 2023, the entire contents of which are incorporated by reference herein.

### TECHNICAL FIELD

The present disclosure relates to a technique for managing a target area based on an image captured by a camera.

### BACKGROUND ART

Patent Literature 1 discloses an image recognition system that tracks a person using images captured by a plurality of cameras. The plurality of cameras captures images of a specific person from different directions. The specific person is tracked by using a plurality of images captured from different directions. The position information of each of the plurality of cameras is used to calculate a relative angle between the plurality of cameras.

### LIST OF RELATED ART

Patent Literature 1: Japanese Laid-Open Patent Application No. 2016-001447

### SUMMARY

Area management process for managing a target area based on an image captured by a camera is considered. When only a stationary camera (fixed camera) is used as a camera, the imaging area is fixed. That is, the target area to be subjected to the area management process is fixed and limited. In this case, accuracy of the area management process is not necessarily sufficient. Increasing the number of stationary cameras to enlarge the target area requires enormous labor and cost.

An object of the present disclosure is to provide a technique capable of flexibly setting a target area when managing the target area based on an image captured by a camera.

One aspect of the present disclosure relates to a management system.

The management system includes processing circuitry.

The processing circuitry communicates with a moving body having a localization function.

The processing circuitry acquires an image captured by a moving camera mounted on a moving body and information on a moving camera position which is a position of the moving body when the image is captured.

The processing circuitry extracts an image of the target area captured by the moving camera as a target area image based on the moving camera position.

The processing circuitry executes area management process for managing a target area based on the target image.

According to the present disclosure, the moving camera is used for the area management process. More specifically, in addition to the image captured by the moving camera, the moving camera position at the time of image capturing is acquired. Based on the moving camera position, the image of the target area captured by the moving camera is extracted as the target image. By using the extracted target image, the area management process related to the target area can be performed.

Since the imaging area of the moving camera used for the area management process is not fixed, the target area to be subjected to the area management process can be set more flexibly. It is possible to cover the target area with the moving camera even if the target area is not covered by a stationary camera. Therefore, the accuracy of the area management process can be improved.

Further, according to the present disclosure, it is not necessary to increase the number of stationary cameras to enlarge the target area. Since the imaging area of the moving camera is not fixed and is flexibly configurable, the target area can be largely expanded even when only a small number of moving cameras are used. That is, according to the present disclosure, it is possible to easily expand the target area of the area management process at low cost.

### BRIEF DESCRIPTION OF DRAWINGS

FIG. 1 is a conceptual diagram for explaining a comparative example;

FIG. 2 is a conceptual diagram for explaining an outline of an embodiment;

FIG. 3 is a block diagram showing an example of a configuration of a management system according to the embodiment;

FIG. 4 is a conceptual diagram showing an example of an image database according to the embodiment;

FIG. 5 is a functional block diagram for explaining a first example of area management process according to the embodiment; and

FIG. 6 is a functional block diagram for explaining a second example of the area management process according to the embodiment.

### DETAILED DESCRIPTION

Embodiments of the present disclosure will be described with reference to the accompanying drawings.

### 1. Overview

“An area management process” managing a target area based on an image captured by a camera is considered. For example, the area management process includes monitoring the target area based on the image. The monitoring includes detection of an abnormality (e.g., accident, trouble, crime, suspicious person, sick person, etc.). As another example, the area management process includes detecting or searching for a target (e.g., a person, an event) in the target area based on the image. Person re-identification for identifying and tracking the same person from a plurality of videos captured by a plurality of cameras is also included in the area management process. In any case, the abnormality or the target can be detected from the image by using a machine learning model.

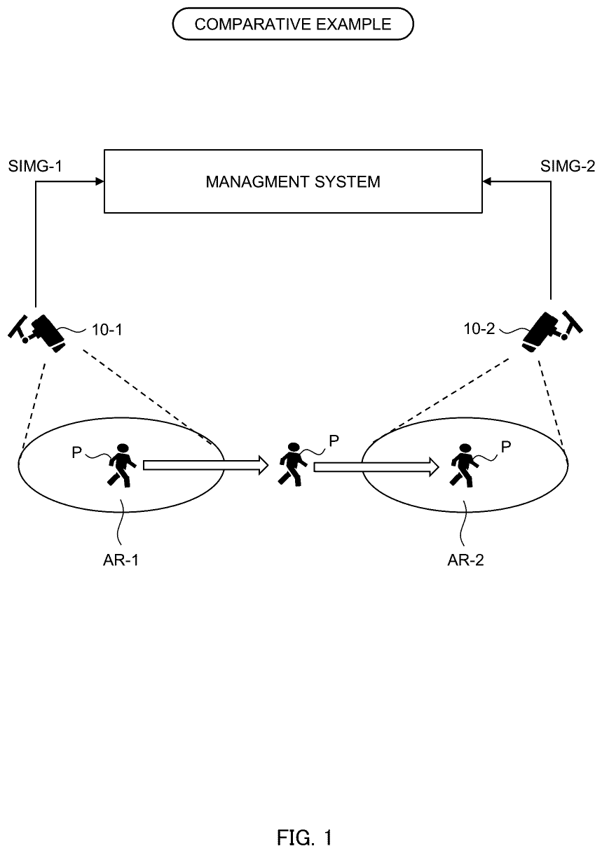

First, a comparative example will be described with reference to FIG. 1. In the comparative example, only a stationary camera 10 (fixed camera) whose installation position is fixed is used for the area management process. The management system communicates with the stationary camera 10 and acquires an image SIMG captured by the stationary camera 10. Then, the management system performs the area management process based on the image SIMG. For example, the management system accumulates the image SIMG and searches for a specific person P from the accumulated image SIMG. As another example, the management system may perform person re-identification based on a plurality of images captured by a plurality of stationary cameras 10.

In the example shown in FIG. 1, the area management process is performed based on the images SIMG-1 and SIMG-2 captured by the stationary cameras 10-1 and 10-2. The imaging areas AR-1 and AR-2 are areas that can be imaged by the stationary cameras 10-1 and 10-2, respectively, and are fixed. That is, the target area to be subjected to the area management process is only the fixed imaging areas AR-1 and AR-2. Because the target area is fixed and limited, accuracy of the area management process is not always sufficient. For example, when the person P goes out of the imaging areas AR-1 and AR-2, the person P cannot be detected.

As described above, when only the stationary camera 10 is used, the target area to be subjected to the area management process is fixed and limited. In this case, the accuracy of the area management process is not necessarily sufficient. Increasing the number of stationary cameras 10 to enlarge the target area requires enormous labor and cost. Therefore, the present embodiment proposes a technique capable of setting the target area more flexibly without increasing the number of stationary cameras 10.

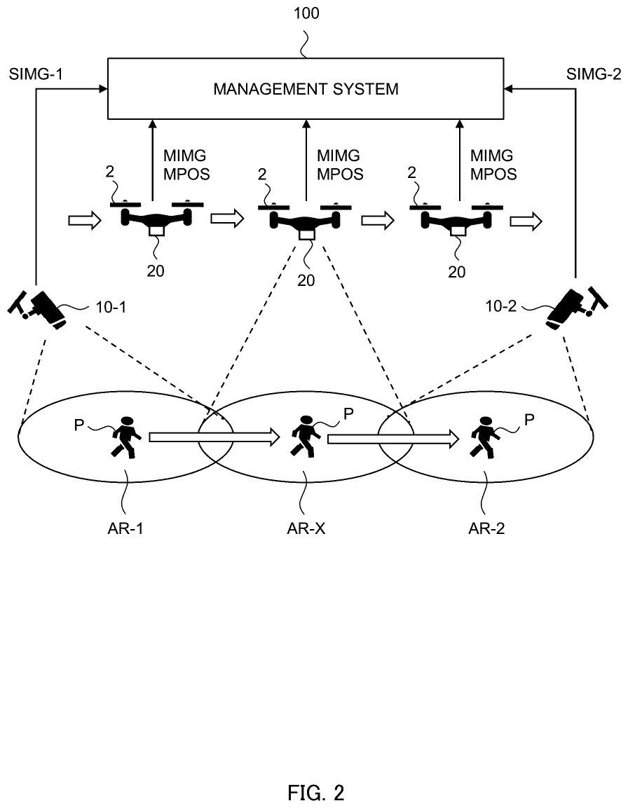

FIG. 2 is a conceptual diagram explaining an outline of the present embodiment. According to the present embodiment, a moving camera 20 mounted on a moving body 2 is used in addition to the stationary camera 10 or instead of the stationary camera 10. The moving body 2 can move around freely. Examples of such the moving body 2 include a vehicle, a robot, and a flying body, etc. The vehicle may be an autonomous driving vehicle or a vehicle driven by a driver. Examples of the robot include a distribution robot. Examples of the flying body include an airplane and a drone.

The moving body 2 has a localization function and can acquire its own position information. For example, the moving body 2 acquires the position information using a global navigation satellite system (GNSS). In the present embodiment, the position of the moving body 2 is regarded as the position of the moving camera 20. The position of the moving body 2, that is, the position of the moving camera 20 is hereinafter referred to as a “moving camera position MPOS”. The moving camera position MPOS is a position in absolute coordinate system and is a position that can be represented on a map.

Unlike the stationary camera 10, the position of the moving camera 20 mounted on the moving body 2 is not fixed. Therefore, the imaging area of the moving camera 20 is not fixed and is flexibly configurable.

The moving body 2 transmits not only an image MIMG captured by the moving camera 20 but also information of the moving camera position MPOS to a management system 100. The management system 100 communicates with the moving body 2. Accordingly, the management system 100 can acquire information of the image MIMG captured by the moving camera 20 and the moving camera position MPOS. The management system 100 may accumulate the information of the acquired image MIMG and the moving camera position MPOS in a database.

The management system 100 may communicate with the stationary camera 10 and acquire the image SIMG captured by the stationary camera 10. The image SIMG may be stored in the database as well.

The management system 100 also holds information on the target area of the area management process. Typically, the target area is specified in advance by an administrator. The management system 100 executes the area management process for managing the target area based on information acquired from a camera group (the stationary camera 10 and the moving camera 20).

In the example shown in FIG. 2, the target area includes at least an area AR-X that is not covered by the stationary cameras 10-1 and 10-2. Such the area AR-X (target area) is not captured by the stationary camera 10, but may be captured by the moving camera 20. The management system 100 can determine whether the area AR-X is captured by the moving camera 20 by comparing the moving camera position MPOS and the area AR-X. When the area AR-X is captured by the moving camera 20, the management system 100 can acquire the image MIMG of the area AR-X.

The image MIMG of the target area captured by the moving camera 20 is hereinafter referred to as a “target image TIMG”. The target image TIMG can also be said to be the image MIMG when the moving camera 20 captures the target area. As described above, the management system 100 can extract the target image TIMG based on the comparison between the moving camera position MPOS and the target area. Then, the management system 100 executes the area management process for managing the target area based on the target image TIMG of the target area.

### Effects

As described above, according to the present embodiment, the moving camera 20 is used for the area management process. More specifically, in addition to the image MIMG captured by the moving camera 20, the moving camera position MPOS at the time of image capturing is acquired. Based on the moving camera position MPOS, the image MIMG of the target area captured by the moving camera 20 is extracted as the target image TIMG. By using the extracted target image TIMG, the area management process related to the target area can be performed.

Since the imaging area of the moving camera 20 used for the area management process is not fixed, it is possible to more flexibly set the target area which is the target of the area management process. It is possible to cover the target area with the stationary camera 20 even if the target area is not covered by the stationary camera 10. Therefore, the accuracy of the area management process can be improved.

Further, according to the present embodiment, it is not necessary to increase the number of stationary cameras 10 to enlarge the target area. Since the imaging area of the moving camera 20 is not fixed but is flexibly configurable, the target area can be largely expanded even when only a small number of moving cameras 20 are used. That is, according to the present embodiment, it is possible to easily expand the target area of the area management process at low cost.

The management system 100 according to the present embodiment will be described in more detail below.

### 2. Configuration Example of Management System

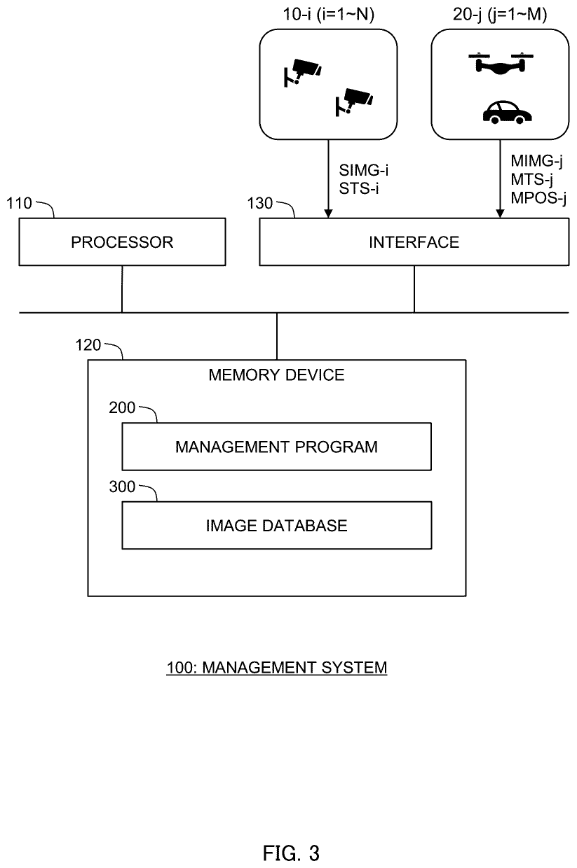

FIG. 3 is a block diagram showing an example of a configuration of the management system 100 according to the present embodiment. The management system 100 includes one or more processors 110 (hereinafter, simply referred to as “processor 110”), one or more memory device 120 (hereinafter, simply referred to as “memory device 120”), and an interface 130. The processor 110 executes a variety of processes. For example, the processor 110 includes a central processing unit (CPU). The processor 110 can be referred as “processing circuitry”. The memory device 120 stores a variety of information necessary for the processes. Examples of the memory device 120 include a hard disk drive (HDD), a solid-state drive (SSD), a volatile memory, and a non-volatile memory. The interface 130 includes a network interface and a user interface. Examples of the user interface include a display device, a touch screen, a keyboard, and a button.

The management program 200 is a computer program for performing the area management process. The management program 200 is stored in the memory device 120. The management program 200 may be recorded in a computer-readable recording medium. The management program 200 is executed by the processor 110. The processor 110 executing the management program 200 and the memory device 120 cooperate with each other to realize the functions of the management system 100.

The processor 110 communicates with the camera group via the interface 130. The camera group includes stationary camera 10-i (i=1 to N) and moving camera 20-j (j=1 to M). Here, N is an integer of 1 or more, and M is an integer of 1 or more. “i” is an identifier of the stationary camera 10-i, ranging from 1 to N. J is an identifier of the moving camera 20-j, ranging from 1 to M.

The processor 110 acquires the image SIMG-i captured by the stationary camera 10-i and time stamp STS-i. The time stamp STS-i is a time at which the image SIMG-i is captured, and is associated with the image SIMG-i. The processor 110 may acquire a stationary camera ID which is identification information of the stationary camera 10-i. The processor 110 may acquire information of a stationary camera position SPOS-i which is an installation position (fixed position) of the stationary camera 10-i.

The processor 110 acquires the image MIMG-j captured by the moving camera 20-j and a time stamp MTS-j. The time stamp MTS-j is the time at which the image MIMG-j is captured, and is associated with the image MIMG-j. Further, the processor 110 acquires information on the moving camera position MPOS-j which is the position of the moving body 2-j when the image MIMG-j is captured. The moving camera position MPOS-j is associated with the image MIMG-j. The processor 110 may acquire a moving camera ID which is identification information of the moving camera 20-j.

The processor 110 accumulates the acquired image and information in an image database 300. The image database 300 is stored in the memory device 120.

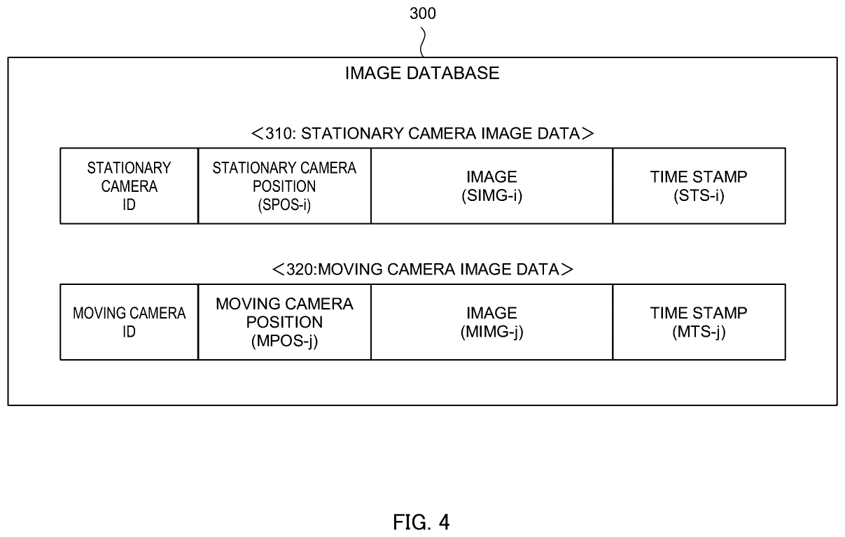

FIG. 4 is a conceptual diagram showing an example of the image database 300. In the example shown in FIG. 4, the image database 300 includes stationary camera image data 310 and moving camera image data 320.

The stationary camera image data 310 indicates a correspondence relation between the stationary camera ID, the image SIMG-i, and the time stamp STS-i. The stationary camera image data 310 may further include the stationary camera position SPOS-i. The stationary camera position SPOS-i may be registered in advance by a user or may be notified from the moving camera 20-j. Preferably, the stationary camera position SPOS-i is a position in absolute coordinate system, which can be represented on a map. In this case, the stationary camera 10 and the moving camera 20 can be handled without distinction.

The moving camera image data 320 indicates a correspondence relation between the moving camera ID, the moving camera position MPOS-j, the image MIMG-j, and the time stamp MTS-j. The moving camera position MPOS-j is a position in absolute coordinate system and can be represented on a map.

The processor 110 executes the area management process for managing the target area by using the image database 300. An example of the area management process will be described below.

### 3. Example of Area Management Process

### 3-1. First Example

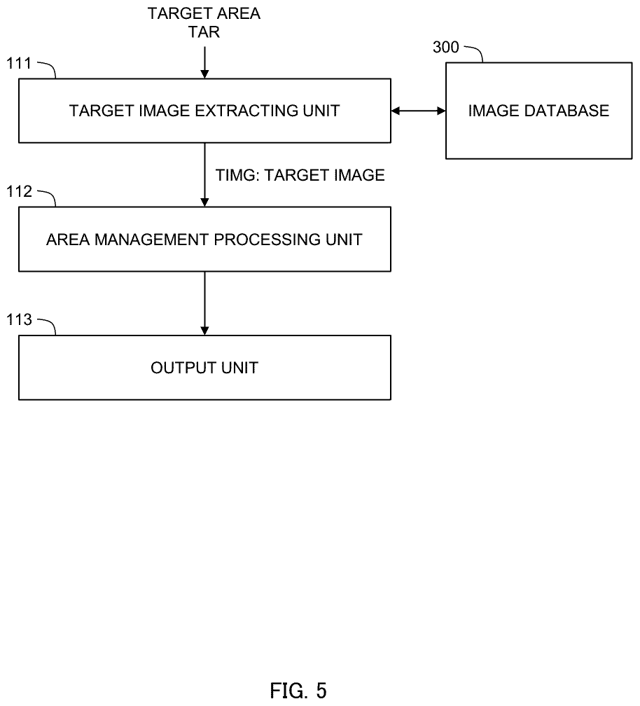

FIG. 5 is a functional block diagram explaining a first example of the area management process. The processor 110 includes a target image extraction unit 111, an area management process unit 112, and an output unit 113 as functional blocks.

The target image extraction unit 111 acquires information of a target area TAR. Typically, the target area TAR is specified in advance by an administrator. The processor 110 extracts the image MIMG of the target area TAR captured by the moving camera 20 as the target image TIMG. More specifically, processor 110 accesses image database 300, and extracts the image MIMG of the target area TAR as the target area image TIMG from the image database 300 (the moving camera image data 320). As described above, the moving camera image data 320 of the image database 300 includes the moving camera position MPOS-j when the image MIMG-j is captured. Thus, the processor 110 can extract the target image TIMG based on the comparison between the moving camera position MPOS-j and the target area.

The target image extraction unit 111 does not extract non-target images from the image database 300. The non-target image is the image MIMG other than the target image TIMG. By not extracting the non-target image, it is possible to reduce a processing load and memory consumption.

The area management process unit 112 executes the area management process based on the target image TIMG. For example, the area management process includes monitoring the target area TAR based on the target image TIMG. The monitoring includes detection of an abnormality (e.g., accident, trouble, crime, suspicious person, sick person, etc.). As another example, the area management process includes detecting or searching for a target (e.g., a person or an event) in the target area TAR based on the target image TIMG. In any case, it is possible to detect an abnormality or a target from the target image TIMG by using a machine learning model.

The output unit 113 presents the result of the area management process by the area management process unit 112 to the user via the user interface.

### 3-2. Second Example

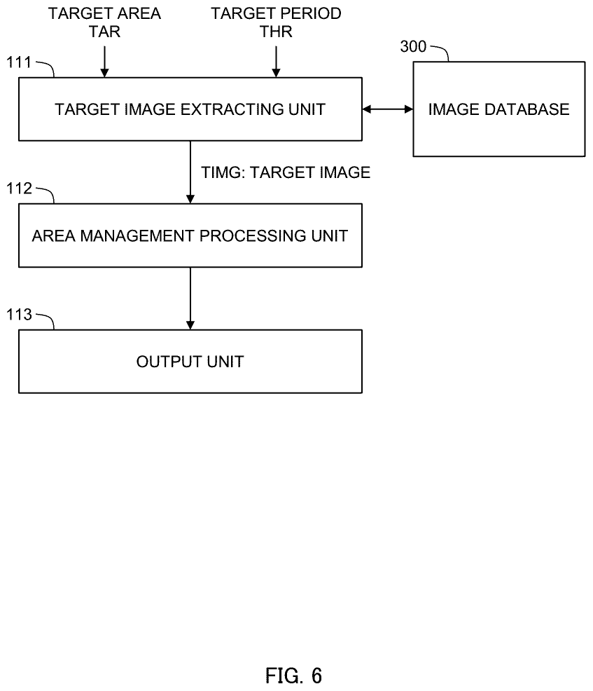

FIG. 6 is a functional block diagram explaining a second example of the area management process. The description overlapping with the first example shown in FIG. 5 will be omitted as appropriate.

The target image extraction unit 111 acquires information of the target period of time THR in addition to information of the target area TAR. Typically, the target period of time THR is specified in advance by the administrator. The processor 110 extracts the image MIMG of the target area TAR captured by the moving camera 20 in the target period of time THR as the target image TIMG. More specifically, the processor 110 accesses the image database 300 and extracts the image MIMG of the target area TAR in the target period of time THR from the image database 300 as the target image TIMG. As described above, the moving camera image data 320 in the image database 300 includes the moving camera position MPOS-j and the time stamp MTS-j when the image MIMG-j is captured. Therefore, the processor 110 can extract the target image TIMG based on the comparison between the moving camera position MPOS-j and the target area and the comparison between the time stamp MTS-j and the target period of time THR.

The other configurations are the same as those of the first example shown in FIG. 5.

What is claimed is:

1. A management system, comprising:
processing circuitry configured to:
communicate with a moving body having a localization function;
acquire an image captured by a moving camera mounted on the moving body and information on a moving camera position that is a position of the moving body when the image is captured;
extract the image of a target area captured by the moving camera as a target image, based on the moving camera position; and
execute an area management process to manage the target area based on the target image.

2. The management system according to claim 1, further comprising one or more memory devices storing an image database, wherein
the processing circuitry is further configured to:
accumulate moving camera image data indicating a correspondence relation between the image and the moving camera position in the image database; and
extract the image of the target area as the target image from the image database, based on the moving camera position.

3. The management system according to claim 1, wherein
the processing circuitry is further configured to:
acquire the image, the information of the moving camera position, and information of a time stamp of the image; and
extract the image of the target area captured by the moving camera in a target period of time as the target image, based on the moving camera position and the time stamp.

4. The management system according to claim 3, further comprising one or more memory devices storing an image database, wherein
the processing circuitry is further configured to:
accumulate moving camera image data indicating a correspondence relation between the image, the moving camera position, and the time stamp in the image database; and
extract the image of the target area in the target period of time as the target image from the image database, based on the moving camera position and the time stamp.

5. The management system according to claim 2, wherein
a non-target image is the image other than the target image, and
the processing circuitry extracts only the target image from the image database without extracting the non-target image and execute the area management process.
